(19) United States
(12) Patent Application Publication
(10) Pub. No.: US 2008/0064622 A1
(43) Pub. Date: Mar. 13, 2008

(54) Rinse Solution for Cleaning and Protecting Surfaces

(76) Inventors: Frank L. Villa, Markham (CA); Larry Leitch, Sharon (CA)

Correspondence Address: PATENT DOCKET ADMINISTRATOR;LOWENSTEIN SANDLER PC, 65 LIVINGSTON AVENUE, ROSELAND, NJ, 07068, US

(21) Appl. No.: 11/573,776

(22) PCT Filed: Aug. 18, 2004
(86) PCT No.: PCT/CA04/01501

§ 371 Date: Oct. 15, 2007

(51) Int. Cl. C11D 3/26; C11D 3/16; C11D 3/33

(52) U.S. Cl. 510/405

(57) ABSTRACT

A fine rinse solution that removes fine particulate, metal-based contaminants and mineral contaminants from man-made surfaces such as painted body panels of an automobile, comprising a rinse agent solution that provides an active rinse phase which sequesters and chelates all of the fine mineral and metal-based particulate acidic and benign deposits from the surface by simply applying and rinsing off the solution. The subsequent oxide seasoning on the finish is left intact, forming a substrate to which the rinse agent can bond, sequester and neutralize acidic mineral and metal-based particulate. Molecules in the rinse agent of the invention chemically bond to embedded oxides in and on the surface forming stable complexes on the paint finish. As fresh deposits arrive on the surface of the finish, the unsaturated stable complexes act to further sequester mineral and metal-based deposits and neutralize, or buffer, acidic deposits.

### FIELD OF THE INVENTION

This invention relates to a rinse agent for removing metal-based contaminants from a surface. In particular, this invention relates to a fine rinse solution that removes fine particulate, metal-based contaminants and mineral contaminants from man-made surfaces such as painted body panels of an automobile.

### BACKGROUND OF THE INVENTION

Surfaces are exposed to the elements of the surrounding atmosphere and are often subject to deterioration and breakdown. Protecting the surface from such breakdown and deterioration is important for maintaining its aesthetic appearance, structural integrity and ensuring it maintains its function as an environmental barrier.

During exposure to the elements, the surface collects contaminants from a variety of sources. Water, either from natural precipitation or from washing the surface, will often contain particulate material, soap and other contaminants. When the water dries, a residue is usually left behind on the finished surface. Particulates may also be deposited on a finished surface as a result of airborne particulates that come to rest on the surface.

In addition to particulates, the atmosphere contains numerous acidic pollutants generated from a variety of sources, most notably from the combustion of fossil fuels. These pollutants chemically react with oxidants and water vapour in the atmosphere to create sulfuric and nitric acids. These acidic compounds combine in precipitation, and after being deposited on the surface the precipitation evaporates leaving behind a dry acidic deposition. This deposition plays a major role in the gradual deterioration of man-made structures, particularly exposed surfaces.

For example, damage to automobiles is of particular concern due to their cost and the impact it has on their aesthetic appearance and bodily integrity. When an automobile paint finish is new, and has had no exposure to the environment, the surface is smooth and glass-like. The surface of the finish will have no micro-porosity to allow environmentally generated oxides, either acidic or neutral, to be deposited and embedded on the surface. Regular washing is able to suspend these contaminants and allow for their removal.

As time passes natural weathering, or seasoning, of the finish will occur. While finish quality will likely appear unchanged to the naked eye, on a microscopic level the finish will have lost much of its resistant, glass-like surface. An even layer of mineral deposits will appear tightly and evenly embedded into the surface of the finish. While acidic deposits do not react with the paint directly, they do attack and corrode the mineral deposits embedded in the surface. As the mineral deposits corrode they leave gaps or pits in the surface of the paint finish. These pits, are attractive sites for fresh mineral deposits to embed themselves into the paint.

With time, the paint will visibly fade and its ability to function as an environmental barrier will be compromised. At this point contaminants will easily embed themselves into the irregular, oxidised surface of the finish and the rate of deterioration will accelerate. Once the finish is unable to act as an environmental barrier, the only recourse is to completely re-finish the vehicle.

There are a variety of accepted methods for preserving and protecting a surface. The methods can be generally separated into two categories, removal of surface contaminants and the provision of an additional boundary layer between the surface of the paint finish and the environment. Generally most surfaces are best protected by a combination of the two methods.

The simplest method of preserving a surface is to wash the surface regularly with a non-abrasive soap. Washing serves to remove mineral and acidic deposition from the surface. This method does have two significant shortcomings. While washing does remove surface deposits, it does not act to protect the surface on an ongoing basis. Deposits that accumulate on the surface may become embedded before they can be washed away. The second shortcoming is that washing with water and soap is not effective at removing embedded deposits and fine particulate.

A more invasive method of removing deposition involves mechanical removal by rubbing the surface with a fine abrasive. The abrasive can be in any form known in the art such as use of a clay bar, a paste rubbing compound, or a buffing wheel. While these methods can be very effective at removing surface deposits, they suffer from two major shortcomings. First, they may require a lot of manual effort and time to treat a larger surface such as the entire surface of a painted article like an automobile.

The technique may require a user to apply several grades of abrasive in succession, proceeding from coarse to progressively finer abrasives. This involves rubbing the entire surface with one grade of abrasive, removing the abrasive, and then applying a finer grade of abrasive and repeating the process. Second, in addition to the time and labour involved, these techniques are actually harmful to the surface as they operate by removing the outermost layer of the finish. For example for the paint finish, after several operations it is possible to remove enough of the outer layer to compromise the ability of the paint finish to act as a boundary layer.

The introduction of a boundary layer to protect some surfaces, e.g. a paint finish, is achieved by applying a wax to the surface. Waxes encapsulate the surface finish and establish a barrier between the surface and the environment. While there are a wide variety of waxes commonly used, they all suffer from the same general drawbacks.

If surface deposits are not removed in an initial step, then the application of wax will serve to entrap deposits under the wax layer. Entrapment can lead to an acceleration of acidic corrosion since any acidic deposits will be held tightly against the surface by the wax layer and will be protected from removal by precipitation or washing.

Waxes are not recommended for some surfaces, such as newly finished paint surfaces as the paint requires up to 60 days to completely cure. During this 60 day period, the solvent carrier continues to emanate from the paint surface. If a wax is applied to a newly finished paint surface, the ability of the solvent carrier to emanate will be hindered. This can result in an incomplete cure and may result in potential defects in the paint finish. Car manufacturers generally recommend that waxes should not be applied until the finish has fully “gassed”, and applying wax to a newly finished product may void any paint warranty associated with the product.

Wax may also cause damage to a surface through both application and normal use. Water that falls on a waxed surface will tend to bead into small water droplets. Droplets can act as a lens and focus sunlight, causing UV and infra-red damage to the surface. The application of wax can also lead to a degradation in the surface as it generally involves the mechanical rubbing of wax onto the surface. While wax is not as abrasive as a rubbing compound, through repeated use and any particulate present on the surface, small scratches in the surface may develop.

Thus there exists a need for a simple, non-mechanical method of cleaning and preserving surfaces. In particular, there is a need for a method that is suitable for application to a variety of surfaces including the exterior of an automobile and is also effective at cleaning and preserving the surface.

### SUMMARY OF THE INVENTION

In one embodiment, the present invention provides a rinse agent solution that provides an active rinse phase which sequesters and chelates all of the fine mineral and metal-based particulate acidic and benign deposits from the surface by simply applying and rinsing off the solution. The solution is safe and effective on a variety of surfaces, particularly non-porous surfaces such as those commonly present on an automobile, e.g. glass, rubber and plastic.

In particular, applying the invention to a non-absorbent surface such as a paint finish in a rinse phase helps to remove and chelate mineral and metal-based surface deposits. The subsequent oxide seasoning on the finish is left intact, forming a substrate to which the rinse agent of the invention can bond, sequester and neutralize acidic mineral and metal-based particulate. Molecules in the rinse agent of the invention chemically bond to embedded oxides in and on the surface forming stable complexes on the paint finish. As fresh deposits arrive on the surface of the finish, the unsaturated stable complexes act to further sequester mineral and metal-based deposits and neutralize, or buffer, acidic deposits.

### BRIEF DESCRIPTION OF THE DRAWINGS

In drawings which illustrate by way of example only a preferred embodiment of the invention:

FIG. 1 illustrates a surface with initial deposition of metal-based deposits;

FIG. 2 illustrates the surface of FIG. 1 during the application and rinse of a solution which is an embodiment of the invention;

FIG. 3 illustrates the surface of FIG. 2 after subsequent treatments with a solution which is an embodiment of the invention.

### DETAILED DESCRIPTION OF THE INVENTION

In an embodiment of the invention there is provided a rinse agent which is safe and effective on a variety of surfaces, particularly non-absorbent surfaces and surfaces which are not discoloured by exposure to water or aqueous solutions generally. This rinse agent provides an active rinse phase which removes unattached fine particulate from a surface. The rinse agent also bonds to surface attached oxides which form a substrate to which the agent can bond and thus sequester and neutralize new deposits of acidic and benign mineral and metal-based particulate. Sequestering components of the rinse agent which are divalent or multivalent chemically bond to embedded oxides in the surface. Thus, when the fresh deposits contact the surface where there are bound sequestering agents, these divalent or multivalent sequestering agents bond to further sequester metal-based deposits and neutralize or buffer acidic deposits. After washing a surface with, for example soap and water, application of the rinse agent to the surface creates an active rinse phase that quickly and effectively helps to remove loosely bound fine particulate matter on the surface, and chelates mineral and metal-based particulate matter whether it is loosely bound or tightly bound in the surface.

A rinse agent embodying the invention includes a sequestering agent that can chemically bond to oxides on the surface. Superficial and unbound surface deposits are sequestered by the agents and then rinsed off the surface in a final rinse. Oxides that have become embedded into or bound onto the surface cannot easily be removed without leaving a hole or pit in the surface. However, the sequestering agents in the rinse agent, instead of removing these deposits, bond using them as anchors to hold the sequestering agents in place and to provide continuous sequestering and neutralization of future oxide deposits.

A variety of sequestering agents or chelators are known. In a preferred embodiment of the invention the rinse agent utilizes ethylene diamine tetraacetic acid (EDTA) as the sequestering agent. However, other sequestering agents or combinations of sequestering agents can be used. Some suitable sequestering agents are: disodium ethylene diamine diacetate; trisodium ethylene diamine triacetate; trisodium nitrilotriacetate; sodium glycolate; hemes and other iron chelators; and pyridoxal isonicotinoyl hydrazone (PIH). Those skilled in the art will appreciate different sequestering agents can be selected but which perform the same function. In the preferred embodiment, the EDTA binds to oxides and metal ions forming complexes. Once an oxide is sequestered to an EDTA molecule, it may either be removed through rinsing, or will act as an anchor to secure the EDTA molecule in place on the surface. Since some EDTA molecules will become anchored to the surface by embedded metal oxide deposits, those EDTA molecules are able to provide a pH buffering for an extended period of time after application of the rinse agent. The pH buffering acts to neutralise acidic deposits and helps prevent embedded oxides from corroding the outer layer of the surface. Each time that surface becomes wet through for example, precipitation or subsequent washing, the bound EDTA is again able to act as a pH buffer in interface between the aqueous environment and the surface. Thus, the bound EDTA further sequesters oxides and buffers the surface.

Measurement of the effectiveness of the sequestering agents, such as those noted above, can be found whether the sequestering agents are used alone or in combination and regardless of the relative concentrations. Effective sequestering has been noted in concentrations as low as 0.0001% by volume, regardless of the surface to which the fine rinse solution was applied. However, the nature of the surface being treated will impact upon the effectiveness of the fine rinse solution in achieving a desired aesthetic appearance. Rough, textured or matte surfaces with low or no reflectivity are more able to achieve the peak protective effect of the fine rinse solution at lower concentrations of the solution since, on these surfaces, excess product (due to higher concentration) is not visually apparent. Thus, these type of surfaces can maintain their aesthetic appearance in a wider range of concentrations than can smooth or glossy surfaces. As a general principle, the more textured the surface the higher the tolerable concentration of sequestering agents that can be tolerated to provide protection without impacting upon aesthetic qualities. Stone and masonry are particularly suitable for treatment with the fine rinse agent since the sequestering agent complexes readily with minerals and metals, a principal component of stone and masonry.

The mechanism of action of the sequestering agents in the rinse agent is figuratively illustrated in FIGS. 1 to 3. FIG. 1 illustrates a surface, in particular a metal surface 1 such as an automobile body panel to which a two stage paint system 2 has been applied. The two stage paint system consists of a base or color coat 3 and a clear coat 4. The diamonds represent the deposit of metal-based oxides onto the surface of the clear coat. Illustrated in FIG. 1 are non-acidic oxides 5 resting on the surface of the clear coat and acidic oxides 6 which have lightly penetrated into the outermost layer of the clear coat. The acidic oxides become acidic due to either wet or dry acidic fallout.

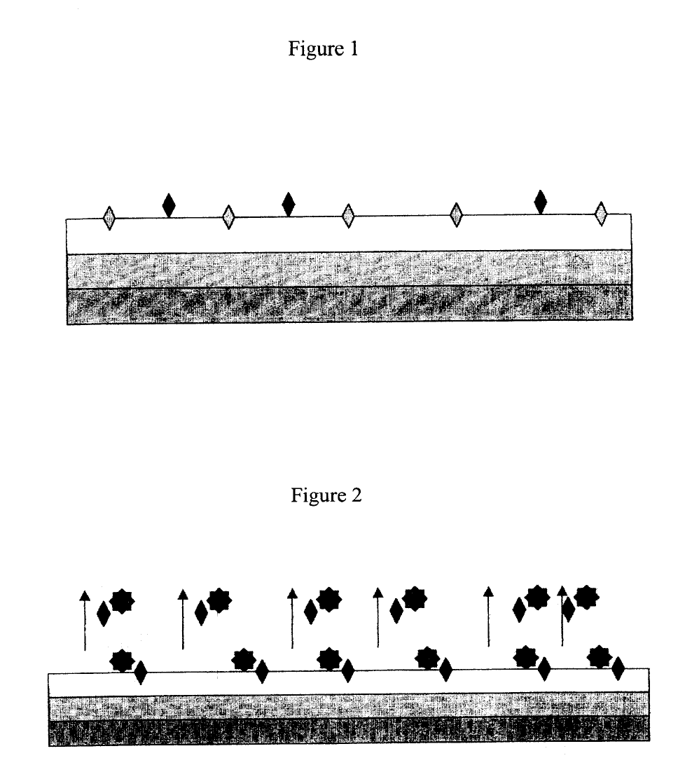

FIG. 2 illustrates the application of a rinse agent which is an embodiment of the invention. Sequestering agent 10 bonds to the acidic oxides, neutralize the acid, and leave neutral oxides embedded in the clear coat. The bonded sequestering agent is held in place on the surface by the embedded oxide and provides ongoing sequestering and neutralization. Non-acidic oxides also bond to sequestering agents. However, since these oxides are not embedded in the clear coat they are removed by water rinsing or precipitation.

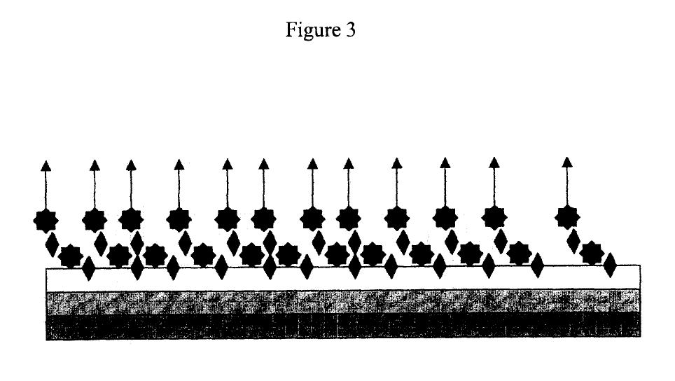

FIG. 3 illustrates the paint system after it has become fully seasoned following treatment of clear coat by the rinse agent. A near continuous layer of embedded neutral oxides are bonded to sequestering agents. Subsequent oxides are either bonded to the bound sequestering agents and neutralized, or carried away by precipitation, washing or rinsing with further applications of the rinse agent.

In addition to a sequestering agent, a preferred embodiment contains an ultra-fine lubricant that acts to hinder the adhesion of future oxide deposits. With lubricant in place, the action of normal precipitation in removing surface deposits is enhanced. The lubricant has the added benefit of improving fine cleaning on glass and also improving the performance of windshield wipers. The residual lubricant also acts as a barrier between the surface and the rinse solution and speeds the dry-up of the rinse and reduces beading. Eliminating beading is beneficial to avoid accumulation of deposits on the surface such as a paint finish.

Lubrication can help improve or maintain the aesthetic appearance of the surface, particularly for smooth and glossy surfaces by maintaining the reflective surface. The principle of lubrication for a spotless, streakless effect on surfaces can be achieved with many forms of lubricant. Examples of suitable lubricants include; plant oil extracts; mineral oils (PCB's); petroleum distillates and synthetic oils. On one embodiment of the invention, lubrication can help improve or maintain the aesthetic appearance of the surface, particularly for smooth and glossy surfaces by maintaining the reflective surface. The effectiveness of the lubricants can be seen over a relatively broad range of concentrations from 0.00001% to 40% by volume. Any single lubricant or possible combination of lubricants either combined with any single chelator or combination of chelators will achieve measurable results.

In the preferred embodiment, lubrication is achieved by the presence of a small amount of kerosene in the formulation. The kerosene acts as a light lubricant, aiding the sheeting and drying-up of the rinse solution. This accounts for much of its spotless-streakless rinse characteristics. A micro-fine layer of kerosene remains on the surface after the rinse operation, filling microscopic low points between the chemical bonds of the sequestering agent and seasoned oxidation. This kerosene layer hinders adhesion of contaminants, helping keep the surface clean between washings. The presence of the layer also assists in the cleaning action of subsequent washings.

In an embodiment of the invention, a formulation relies upon three activities for its utility: solvency, sequestering and lubrication. Solvency is required for all cleaning operations. Water, acts as a natural solvent and emulsifies fine contaminants. The surface tension of water has an effect on its solvency. Harder water has an increased surface tension, and a corresponding reduced natural solvency. This preferred formulation uses tetrasodium EDTA, a metal scavenger, to soften the rinse water. Softening the rinse water improves its solvency. This rinse agent solution comprises the following ingredients in the following proportions:

TABLE 1
Preferred Formula Composition

| | Concentrate | Diluted |
|---|---|---|
| Ingredient | % (vol) | % (vol) |
| Tetrasodium ethylene | 23.6 | 0.040 |
| diamine tetraacetate (EDTA) | | |
| Sodium Glycolate | 2.0 | 0.003 |
| Sodium Hydroxide | 0.6 | 0.001 |
| Trisodium EDTA | 0.6 | 0.001 |
| Disodium EDTA | 0.6 | 0.001 |
| Trisodium | 0.6 | 0.001 |
| nitrilotriacetate | | |
| Kerosene | 18.0 | 0.030 |
| Methyl Hydrate | 9.0 | 0.015 |
| Water | 45.0 | 99.91 |

The nature of the surfaces to which a fine rinse solution falling within the scope of the invention can be applied is diverse. For example, the fine rinse solution can be applied to plastic and leather surfaces. In addition, the fine rinse solution has proven useful on many other surfaces listed below: Plastics and synthetics (EPS polystyrene; polyester; urethane; polyurethane; styrene; nylon; vinyl; rubber; lexan; ABS; PVC; LDPE); cured polyester resin associated composites such as fibreglass, carbon fiber, and Kevlar; metapolymers including aluminum and other oxides blended with polyester resin; cured epoxies; electroplated surfaces; all polymers; and all monomers); all painted and/or stained surfaces, e.g. woods-exterior building; all painted plastics; all painted metals; glass (silica); leather; and stone and masonry (marble; sandstone; granite; limestone; gneiss; schist; soapstone; flagstone; clay (brick); concrete (cement and mortar); modified concrete (e.g. glass fibre impregnated, high-strength concrete); asphalt; and exterior stuccos that are cement based. The fine rinse solution can also be used to treat porous and semi-porous objects such as untreated wood where temporary or permanent discoloration due to the absorption of the solution is of no concern. In this way the solution is used to preserve the object rather than simply treat the surface.

The fine rinse solution may be used on a variety of surfaces including some porous surfaces, but may not be suitable on absorbent surfaces due to impact upon the aesthetic appearance of the surface. The potential risk with absorbing surfaces is due to the fact that the fine rinse solution is comprised primarily of water. Although there is no detriment in doing so application to very absorbent surfaces may render a darkening effect due to the absorption of the water component. Ultimately, it is up to the end user's personal preference whether any alteration in coloration of certain items (usually temporarily, until the water evaporates) is acceptable in any given application in return for the protective attributes offered by the fine rinse solution.

In a further embodiment, the invention provides a method of helping to remove and chelate metal-based particulate from surfaces and objects using a fine rinse agent containing sequestering agents as described above. This method is particularly useful on painted or waxed surfaces since one of the main drawbacks of wax is that acidic oxides are fixed to the surface. However, by using the method of the invention for applying a sequestering and neutralizing agent prior to waxing, the wax coat will not entrap any harmful acidic oxides against the surface of the finish.

In this preferred embodiment of the invention the surface to be treated is first rinsed with an initial de-soiling rinse. The purpose of this rinse is to remove large particulate matter and grit from the surface. After the de-soiling rinse, the surface is washed by a soil emulsifying soaping which any of several commercially available soaps suitable for the particular surface. The third step of this method is a rinse to remove soap and dirty wash water from the surface. Ideally, water is used for this rinse. The fourth step of this method requires application of a fine rinse agent containing at least one sequestering agent and a lubricant as described above, to the washed surface.

It is common in the industry to provide washing or rinse solutions in concentrated form. Accordingly, where the fine rinse solution is provided in a concentrated form the first step in preparing that fine rinse solution for application is to dilute the solution in clean, sediment-free, water. Ideally the water will be distilled deionized water. The fine rinse solution is then applied to the surface. On some surfaces the fine rinse solution may be applied using a medium. For example, on a painted surface of a car the fine rinse solution can be applied by wetting a chamois with the rinse solution in diluted form. On most surfaces the most effective method of application of the fine rinse solution is achieved by commencing each washing or rinsing step at the uppermost part of the surface to be treated and working down to the lowermost portions of the surface. In this way, any particulate rinsed from the top of the surface will drain to the unrinsed lower portion and may be subsequently rinsed from that area. Preferably, after applying the fine rinse solution to all areas of the surface, the excess solution should be wiped off all surfaces starting from the first point of application and following the same order for wiping as for application of the solution.

Several tests have been conducted to demonstrate the efficacy of the fine rinse solution which is an embodiment of the invention. In one test a series of assays were conducted to measure the ability of the fine rinse solution to provide continual buffering/pH lending after application of the fine rinse solution. These assays were conducted by measuring pH levels of recent precipitation in the form of collected snowfall melt and then on snowfall melt after it had been applied to the painted surface of a test vehicle that had previously been treated with a fine rinse solution which was a preferred embodiment of the invention. pH levels were measured using colorpHast® indicator strips. The pH of snowfall melt after it had been applied to the painted surface of a test vehicle that had not been treated with a fine rinse solution was used as a control measurement. The results of those assays, summarized below in Table 2 show that the fine rinse solution was still present and active as a pH buffer on the painted surface of the test vehicle.

TABLE 2
Continual Neutralization of Surface Acidity

| | | Days | | Snowfall |
|---|---|---|---|---|
| | | Elapsed | Collected | Melt on |
| | | Since | Snowfall | Test |
| Automobile | Paint | Application | pH | Vehicle |
| 1987 | Sherwin | 21 | 5.3 | 7.0 |
| Plymouth | Williams | | | |
| Voyageur | 2 stage | | | |
| Van | Polyester Color | | | |
| | Base/Urethane | | | |
| | Clear Top Coat | | | |
| 2002 Saturn | N/A | 21 | 5.0-5.2 | 7.0-7.2 |
| Sport Sedan | 2 stage | | | |
| | Polyester Color | | | |
| | Base/Urethane | | | |
| | Clear Top Coat | | | |
| Miscellaneous | N/A | No | 5.3 | 5.3 |
| Automotive | 2 stage | Application | | |
| Panel | Polyester Color | | | |
| | Base/Urethane | | | |
| | Clear Top Coat | | | |
| 1988 | BASF | 21 | 5.3 | 7.0-7.2 |
| Chevrolet | 2 stage | | | |
| Astro Van | Polyester Color | | | |
| | Base/Urethane | | | |
| | Clear Top Coat | | | |
| 2002 Saturn | N/A | 44 | 5.2 | 7.0 |
| Sport Sedan | 2 stage | | | |
| | Polyester Color | | | |
| | Base/Urethane | | | |
| | Clear Top Coat | | | |
| 1988 | BASF | 44 | 5.2 | 7.0 |
| Chevrolet | 2 stage | | | |
| Astro Van | Polyester Color | | | |
| | Base/Urethane | | | |
| | Clear Top Coat | | | |

Other tests requiring a visual inspection of the treated surface were also undertaken. One such visual inspection involved an examination of painted panels from various automotive vehicles following application to that painted surface of a fine rinse solution falling within the scope of the invention. The purpose of this visual inspection was to determine whether the formulation has invasive characteristics that cause damage to the paint surface, and to observe any changes to that surface visible to the eye.

One visual inspection test involved the removal of light surface oxidation from a completely re-finished vehicle ten months after the complete re-finish. In this assay, the test vehicle was a 1987 Plymouth Voyageur Van, that was re-finished with a two stage base/clear coat comprised of a polyester base color coat and a urethane clear top coat. Ten months later, that re-finished vehicle was washed to remove large particulate matter, then rinsed with water. Subsequently a fine rinse formulation falling within the scope of the invention applied to half the painted surface of the test vehicle. That test vehicle was then visually inspected for reflectivity in a well-lit spray booth environment. A tactile comparison of the test vehicle was also conducted comparing the treated versus non-treated surfaces. The fine rinse solution was then re-applied a second and third time, with a visual and tactile inspection after each treatment. It was apparent from these inspections that after each treatment of the test vehicle with the fine rinse solution the reflectivity of the paint surface as well as the smoothness of the surface improved.

Similar visual and tactile inspections were conducted to investigate the impact of the fine rinse solution on recently painted surfaces. In particular, the inspections were conducted to determine whether the fine rinse solution had any invasive characteristics on recently painted surfaces. In this assay, the test vehicle was a 1964 Plymouth Fury. The test vehicle was re-finished with a two stage base/clear coat comprised of a polyester base color coat and a urethane clear top coat. Within two days of re-finishing the test vehicle was washed and rinsed to remove particulate matter. Subsequently, the re-finished painted surface of the test vehicle was treated with the fine rinse solution. The resulting paint surface was subject to a visual inspection for reflectivity in a well-lit spray booth environment and a tactile inspection by passing the hand over treated versus non-treated surfaces. Based upon these inspections there was no evidence of damage to the new paint finish or of invasive characteristics for the fine rinse solution.

A further assay was performed to determine whether the fine rinse solution had any invasive characteristics on highly compounded painted surfaces. About one month of the inspection described above, the Plymouth Fury test vehicle was bee color-sanded and compounded to achieve a perfectly smooth, paint defect-free surface with a mirror-like reflectivity. This test vehicle was then rinsed to remove particulate matter and then the fine rinse solution was applied to the vehicle. Subsequently, this test vehicle was visually inspected for reflectivity in a well-lit spray booth environment, and subject to tactile inspection by passing the hand over treated versus non-treated surfaces. Again there was no evidence of damage or invasive characteristics to the highly compounded, newly painted finish.

Another visual inspection test was conducted to determine how effective the fine rinse solution was at removing the accumulation of heavy surface oxidation on a 1988 Chevrolet Astro van with a 16 year old finish. The test was conducted on the original factory applied top coat. The paint was a two stage base/clear coat comprised of a polyester base color coat and a urethane clear top coat. Prior to treatment a noticeable amount of surface oxidation was detected through visual examination as evidenced by a loss of the original lustre and reflectivity in the paint finish. After washing the vehicle, a fine rinse solution falling within the scope of the invention of the preferred embodiment was applied to half the vehicle. The vehicle was visually inspected, and subjected to a tactile inspection by passing a hand over the treated versus non-treated paint surfaces. The result was a noticeable improvement in the appearance and feel of the paint finish that had been treated with the fine rinse solution compared to the untreated portion. Subsequent additional applications of the fine rinse solution yielded a further apparent improvement in the appearance and feel of the treated paint finish.

A further visual inspection was conducted to determine how effective the fine rinse solution was at removing oxidation from heavily oxidized finishes. This test was conducted by applying the fine rinse solution to sample blanks of painted automobile surfaces severed from a thirty four year old and a thirty six year old automobile. The original paint finishes of these sample blanks had thus been oxidized and corroded by some thirty four and thirty six years of environmental exposure. The fine rinse solution was separately applied to a set of the thirty four year old blanks for 10, 60 and 90 minutes. It was visually apparent that the greater the application time the more oxidation was removed. The formulation was also applied to the thirty six year old blank for 20 minutes. It was apparent that oxidation was removed from the thirty six year old blank. However, due to the age and extreme degree of oxidation and corrosion present on the blanks the formulation could not restore the original lustre of the finish.

Various embodiments of the present invention having been thus described in detail by way of example, it will be apparent to those skilled in the art that variations and modifications may be made without departing from the invention. The invention includes all such variations and modifications as fall within the scope of the appended claims.

1. A rinse solution for cleaning and protecting surfaces from weathering and deterioration comprising an aqueous solution having a pH buffering capacity and having at least one multivalent sequestering agent for bonding to mineral and metal-based particulate embedded within surfaces thereby leading to the formation of a protective sequesterant layer capable of sequestering and neutralizing future deposits.

2. The use of claim 1 wherein the at least one sequestering agent is selected from a group consisting of ethylene diamine tetraacctic acid, disodium ethylene diamine diacetate, trisodium ethylene diamine triacetate, trisodium nitrilotriacetate, sodium glycolate, hemes and pyridoxal isonicotinoyl hydrazone.

3. The use of claim 1 wherein at least one sequestering agent is ethylene diamine tetraacetic acid.

4. The use of claim 1 wherein the total percentage by volume of the sequestering agents in the rinse solution is at least 0.0001%.

5. The use of claim 1 wherein the rinse solution includes at least one lubricant.

6. The use of claim 5 wherein the lubricant is selected from plant oil extracts, mineral oils, synthetic oils and petroleum distillates.

7. The use of claim 5 wherein the lubricant is kerosene.

8. The use of any one of claim 5 wherein the total percentage by volume of the lubricant in the rinse solution is from 0.00001% to 40%.

9. The use of claim 1 wherein the surface is a non-absorbent surface.

10. The use of claim 1 wherein the surface is selected from a group consisting of expandable polystyrene (EPS), polyester, urethane, polyurethane, styrene, nylon, vinyl, rubber, lexan, acrylonitrile butadiene styrene (ABS), polyvinyl chloride (PVC), low density polyethylene (LDPE), cured polyester resin associated composites, □iberglass, carbon fiber, Kevlar, metapolymers, aluminum oxide blended with polyester resin, cured epoxies, electroplated surfaces, painted wooden surfaces, stained wooden surfaces, painted plastics, painted metals, silica glass, leather, marble, sandstone, granite, limestone, gneiss, schist, soapstone, flagstone, clay brick, concrete, modified concrete, asphalt; and cement-based stuccos, and untreated wood.

11. A rinse solution for cleaning and protecting surfaces from weathering comprising an aqueous solution having a pH buffering capacity and having at least one multivalent sequestering agent for bonding to mineral and metal-based particulate embedded within surfaces thereby leading to the formation of a protective sequesterant layer capable of sequestering and neutralizing future deposits.

12. The rinse solution of claim 11 comprising as a percentage by volume 0.04% tetrasodium ethylene diamine tetra-acetate, 0.003% sodium glycolate, 0.001% sodium hydroxide, 0.001% trisodium ethylene diamine tetra-acetate, 0.001% disodium ethylene diamine tctra-acctatc, 0.001% trisodium nitriloacetate, 0.03% kerosene, and 0.015% methyl hydrate.

13. A solution for cleaning and protecting porous and semi-porous materials from weathering, microbial growth and degradation comprising an aqueous solution having a pH buffering capacity and having at least one multivalent sequestering agent for bonding to mineral and metal-based particulate embedded within surfaces thereby leading to the formation of a protective sequesterant layer capable of sequestering and neutralizing future deposits.

14. The use of claim 6 wherein the total percentage by volume of the lubricant in the rinse solution is from 0.00001% to 40%.

15. The use of claim 7 wherein the total percentage by volume of the lubricant in the rinse solution is from 0.00001% to 40%.
